(19) United States
(12) Patent Application Publication
(10) Pub. No.: US 2008/0092164 A1
(43) Pub. Date: Apr. 17, 2008

(54) PROVIDING A SUPPLEMENTAL CONTENT SERVICE FOR COMMUNICATION NETWORKS

(76) Inventors: Anjana Agarwal, Wheaton, IL (US); Maria R. Azada, Naperville, IL (US); David S. Benco, Winfield, IL (US); Anne Y. Lee, Naperville, IL (US); Byron J. Williams, Chicago, IL (US)

Correspondence Address: DUFT BORNSEN & FISHMAN, LLP, 1526 SPRUCE STREET, SUITE 302, BOULDER, CO, 80302, US

(21) Appl. No.: 11/535,933

(22) Filed: Sep. 27, 2006

(51) Int. Cl. G06F 13/00; H04N 7/16; H04N 5/445; G06F 3/00

(52) U.S. Cl. 725/40; 725/135

(57) ABSTRACT

Communication networks and methods are disclosed that provide a supplemental content service. The supplemental content service provides synchronized supplemental content, such as media clips, to a user over a communication network (e.g., a mobile wireless network). A content provider offering a primary content stream (e.g., a television program) broadcasts the primary content stream to a content receiving device (e.g., a television) of the user. The content provider also generates supplemental content that is an enhancement to the primary content stream. If the user subscribes to the supplemental content service, then the communication network provides the supplemental content to the user through a communication device (e.g., a mobile phone) that is synchronized with the primary content stream. The user can then experience the supplemental content over the communication device at the same time as experiencing the primary content stream over the content receiving device.

### BACKGROUND OF THE INVENTION

1. Field of the Invention

The invention is related to the field of communication networks and, in particular, to providing a supplemental content service for communication networks. More particularly, the supplemental content service provides media clips or other supplemental content to a user over a communication network to enhance the presentation of a primary content stream, such as a broadcast television program, to the user.

2. Statement of the Problem

Most households subscribe to over-the-air television, satellite television, or cable television to receive television programs as a form of entertainment. To provide the television service, television stations or other content providers broadcast television signals over the appropriate medium for receipt by a television or other suitable receiving device (e.g., a cable receiver or satellite receiver). The television signals represent multiple television programs, where each television program typically includes an audio portion and a video portion. When a user selects a particular television program, the television displays the video and plays the audio for the television program so that the user can enjoy the program. The television stations may at times transmit a television program having content in addition to the typical audio and video. In one example, closed captioning (CC) is a feature where text captions are displayed on the television screen to transcribe what is said and indicate other relevant sounds during the television program. The content for the closed captioning is often transmitted in the same television signal as the television program. In another example, simulcasting is a feature where a television program may be broadcast across more than one medium. For instance, a music concert may be simulcast over television airwaves and FM radio airwaves so that the concert may be viewed over the television and heard over a high fidelity audio system.

Unfortunately, television viewing is passive in nature meaning that the viewer is limited to watching the video and listening to the audio of the television program that were transmitted in the television signal. Even with closed captioning or simulcasting, the extra content provided is simply a derivative or duplicative of the actual audio of the television program and does not change the passive nature of the television viewing experience. Television production companies and other content providers may desire to involve a viewer more actively in a television program to enhance the viewer's enjoyment.

### SUMMARY OF THE SOLUTION

The invention solves the above and other related problems by enhancing television programs, or other types of content streams, through a supplemental content service that provides media clips or other supplemental content to a user over a communication network (e.g., a mobile wireless network). The user may then view or listen to the supplemental content through his/her communication device (e.g., a mobile phone). A content provider offering a primary content steam (e.g., a television program) broadacast the primary content stream to a content receiving device (e.g., a television) of the user. The content provider also generates media clips that are supplements or enhancements to the primary content stream. If the user subscribes to the supplemental content service, then the communication network provides the media clips to the user through a communication device. The user can then experience the supplemental media clips over the communication device at the same time as experiencing the primary content stream over the content receiving device. The supplemental media clips can advantageously enhance how the user views or listens to the primary content stream.

As an example, a content provider may broadcast a television program for receipt by a television of the user. The content provider may also transmit one or more video clips to a mobile wireless network, where the mobile wireless network provides service to a mobile device of the user. The video clips are supplements to the television program. If the user subscribes to the supplemental content service, then the mobile wireless network transmits the video clips to the mobile device of the user at the appropriate time. For instance, if one of the characters in the television program receives information on his/her cell phone, then the video clip provided to the mobile device of the user may show the actual information received by the character in the television program. The information provided in the video clip may only be available to the subscribers of the supplemental content service, which allows for a more active participation by the user in the television program.

One embodiment of the invention comprises a method of providing supplemental content by a content provider. The method includes the steps of generating a primary content stream and generating supplemental content. The supplemental content, such as one or more media clips, enhances the primary content stream when the supplemental content and the primary content stream are provided to a user. The method further includes broadcasting the primary content stream to a content receiving device of the user, such as a television. The method also includes transmitting the supplemental content to a communication network, such as a mobile wireless network. The communication network is adapted to transmit the supplemental content to the user through a communication device, such as a mobile phone.

Another embodiment of the invention comprises a method of operating a communication network to provide a supplemental content service to the user. One step of the method comprises receiving supplemental content, such as one or more media clips, from the content provider. Another step of the method includes transmitting the supplemental content to a communication device of the user. The supplemental content, when communicated to the user by the communication device, supplements the primary content stream when the primary content stream is communicated to the user by the content receiving device.

The invention may include other exemplary embodiments described below.

### DESCRIPTION OF THE DRAWINGS

The same reference number represents the same element or same type of element on all drawings.

FIG. 1 illustrates an environment for providing a supplemental content service in an exemplary embodiment of the invention.

FIG. 2 is a flow chart illustrating a method of providing supplemental content as performed by a content provider in an exemplary embodiment of the invention.

FIG. 3 is a flow chart illustrating a method of providing supplemental content as performed by a communication network in an exemplary embodiment of the invention.

FIG. 4 is a flow charting illustrating a method of synchronizing the supplemental content in an exemplary embodiment of the invention.

FIG. 5 is a flow charting illustrating another method of synchronizing the supplemental content in an exemplary embodiment of the invention.

FIG. 6 is a flow charting illustrating another method of synchronizing the supplemental content in an exemplary embodiment of the invention.

FIG. 7 is a method of implementing policy-based decision function in an exemplary embodiment of the invention.

FIG. 8 illustrates another environment for providing a supplemental content service in an exemplary embodiment of the invention.

FIG. 9 is a message diagram illustrating messaging in an IMS network to provide the supplemental content service in an exemplary embodiment of the invention.

FIG. 10 illustrates another environment for providing a supplemental content service in an exemplary embodiment of the invention.

FIG. 11 is a message diagram illustrating messaging in an IMS network and a mobile wireless network to provide the supplemental content service in an exemplary embodiment of the invention.

### DETAILED DESCRIPTION OF THE INVENTION

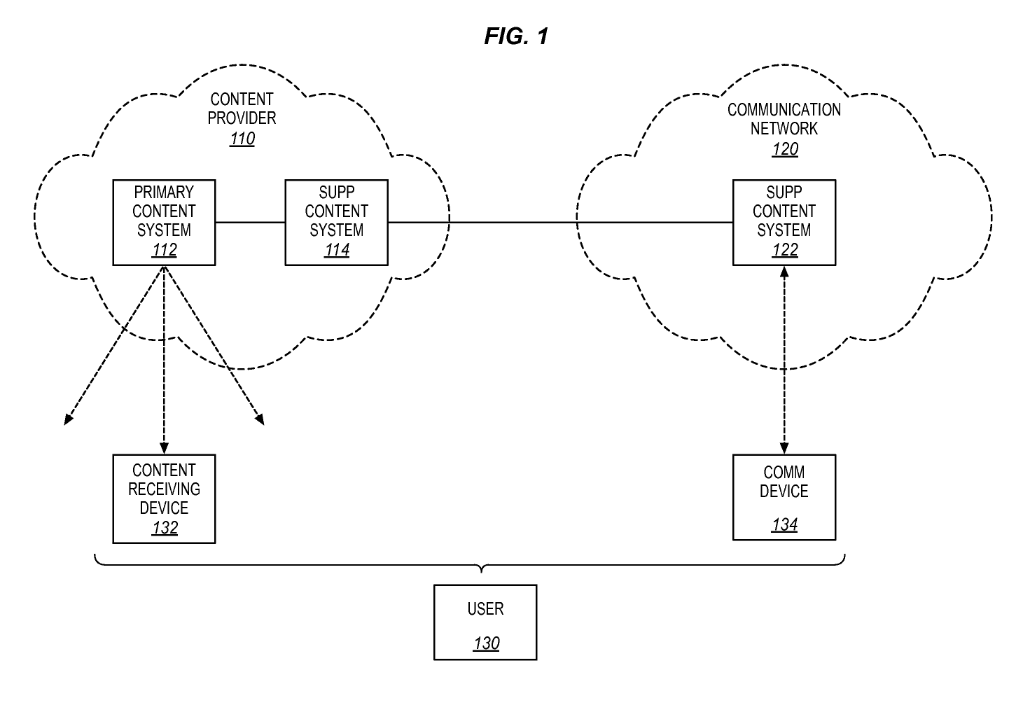

FIGS. 1-11 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an environment for providing a supplemental content service in an exemplary embodiment of the invention. FIG. 1 illustrates a content provider 110 that comprises any company, organization, or other entity that produces or distributes content. Content comprises any data, information, signals, etc, used for entertainment purposes, such as a television program, a radio program, etc. Examples of content provider 110 are television production or distribution companies, movie production or distribution companies, radio production or distribution companies, etc. Content provider 110 is adapted to generate, record, provide a primary content stream. Content provider 110 includes a primary content system 112 that is adapted to broadcast (or unicast or multicast) the primary content stream to a plurality of content receiving devices, such as content receiving device 132. Content receiving device 132 comprises any device, system, or component adapted to receive and process a content stream in order to communicate, display, play or otherwise present the content to user 130. Examples of content receiving device 132 include a television, a radio, a cable receiver and a television, a satellite receiver and a television, etc.

Primary content system 112 provides one-way communication to content receiving device 132, such as a broadcast of a television signal to a television. Primary content system 112 may provide limited two-way communications in some embodiments, such when communicating with a satellite receiver or cable receiver. However, a two-way communication such as this has a much higher downstream bandwidth (from primary content system 112 to content receiving device 132) than the upstream bandwidth (from content receiving device 132 to primary content system 112).

In addition to the primary content stream, content provider 110 is also adapted to generate, record, or provide a supplemental content. Supplemental content comprises any content that supplements, adds to, clarifies, or otherwise enhances the primary content stream. The supplemental content is intended to be in addition to the primary content stream, meaning that the supplemental content is not simply duplicative of the primary content stream in whole or in part. For instance, if the primary content stream comprises a television program, then the supplemental content is not merely the audio from the actual television program, such as for a simulcast of the program. The supplemental content comprises additional content that a user would not experience having only viewed or listened to the primary content stream. The supplemental content may relate directly to the primary content stream, or may be a corollary to the primary content stream, such as advertising material, a movie trailer, etc. Examples of the supplemental content include video clips, audio clips, text messages, digital pictures, or other types of content which can be generally referred to herein as media clips. A media clip is a short segment of media, such as an audio clip, a video clip, or a multimedia clip. Content provider 110 includes a supplement content system 114 that is adapted to transmit the supplemental content to one or more communication networks, such as communication network 120.

Communication network 120 comprises any network adapted to provide a communication service to communication devices, such as communication device 134 of user 130. The communications between network 120 and device 134 are typically two-way communications, but one-way communications (e.g., push-to-talk type applications) are also within the scope of the invention. Communication network 120 may comprise a mobile wireless network, such as a CDMA or GSM network, or may comprise a wireline network. Communication network 120 may also have a circuit-based core network or a packet-based core network, such as an IMS network. Communication network 120 includes a supplemental content system 122 that is adapted to receive supplemental content from content provider 110, and to transmit the supplemental content to communication device 134. Communication device 134 may comprise a mobile device, such as a mobile phone, a PDA, a portable computer, etc, or may comprise a wireline device, such as a wireline phone, a desktop computer, etc. Communication device 134 is secondary or auxiliary to content receiving device 132 in providing content to user 130. Content receiving device 132 is the device that is providing the primary content stream to user 130, while communication device 134 is a secondary device that is used to supply smaller segments of content to user 130 in order to enhance the experience of user 130.

Communication network 120 may be owned or operated by a service provider, such as Sprint, Verizon, Cingular, Qwest, etc. The service provider for communication network 120 may associate with content provider 110 to provide the supplemental content service described herein.

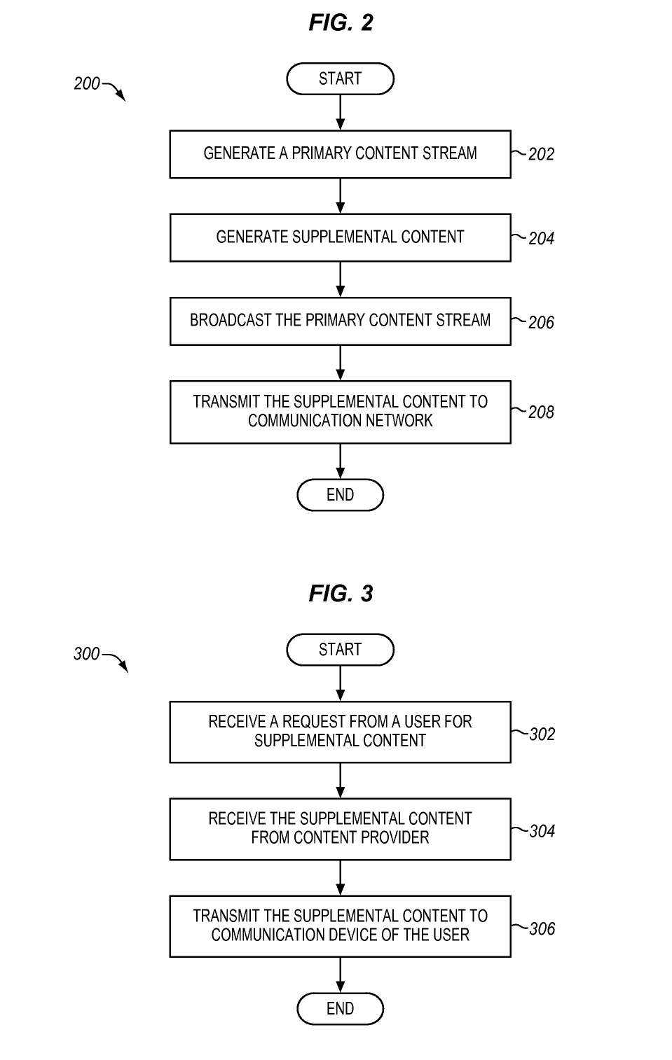

FIG. 2 is a flow chart illustrating a method 200 of providing supplemental content as performed by content provider 110 in an exemplary embodiment of the invention. The steps of method 200 will be described with reference to FIG. 1. The steps of the flow chart in FIG. 2 are not all inclusive and may include other steps not shown.

In step 202, content provider 110 generates the primary content stream. The primary content stream may comprise a television program, a radio program, etc. In step 204, content provider 110 also generates the supplemental content that is associated with the primary content stream so as to enhance the primary content stream. In step 206, primary content system 112 broadcasts the primary content stream. In this embodiment, the broadcast of the primary content stream is intended to be received by content receiving device 132 and other receiving devices within range of the broadcast. In step 208, supplemental content system 114 transmits the supplemental content to communication network 120.

FIG. 3 is a flow chart illustrating a method 300 of providing supplemental content as performed by communication network 120 in an exemplary embodiment of the invention. The steps of method 300 will be described with reference to FIG. 1. The steps of the flow chart in FIG. 3 are not all inclusive and may include other steps not shown.

In step 302, supplemental content system 122 receives a request from user 130 for supplemental content associated with the primary content stream provided by content provider 110. Supplemental content system 122 may receive the request in the form of user 130 subscribing to the supplemental content service as a monthly service. Supplemental content system 122 may alternatively receive the request from user 130 on-demand for a particular primary content stream, such as a particular television program. In step 304, supplemental content system 122 receives the supplemental content from supplemental content system 114 of content provider 110. In step 306, supplemental content system 122 transmits the supplemental content to communication device 134 of user 130. Supplemental content system 122 may transmit or deliver the supplemental content to communication device 134 in many desired forms. For instance, supplemental content system 122 may transmit the supplemental content as a call to communication device 134, as a text message or multimedia message, or as an email message or instant message. Supplemental content system 122 may alternatively broadcast the supplemental content to communication device 134, such as through MediaFLO™ from QUALCOMM, or a Broadcast and Multicast Service (BCMCS) as suggested by 3GPP2.

Communication device 134 receives the supplemental content and communicates the supplemental content to user 130 through an audio and/or a video interface. “Communicating” content to a user refers to displaying, playing (audio), or otherwise presenting the content to the user. Concurrently, content receiving device 132 communicates the primary content stream to user 130 through an audio and/or a video interface. The supplemental content, when communicated to user 130 by communication device 134, supplements the primary content stream when the primary content stream is communicated to user 130 by content receiving device 132. Providing the supplemental content while user 130 is viewing or listening to the primary content stream advantageously provides user 130 with a more interactive and enjoyable experience.

The timing of when the supplemental content is communicated to user 130 may be important. For instance, the supplemental content may be synchronized with the primary content stream. The supplemental content is synchronized so that particular supplemental content, when communicated to user 130 by communication device 134, relates to the portion of the primary content stream being communicated to user 130 by content receiving device 132. As an example, content provider 110 may generate a media clip that is synchronized with a two-minute segment in a television program. The media clip is thus synchronized so that it is displayed or played to user 130 by communication device 134 while this two-minute segment of the television program is being displayed or played to user 130 by content receiving device 132. The synchronization may be accomplished in a variety of ways.

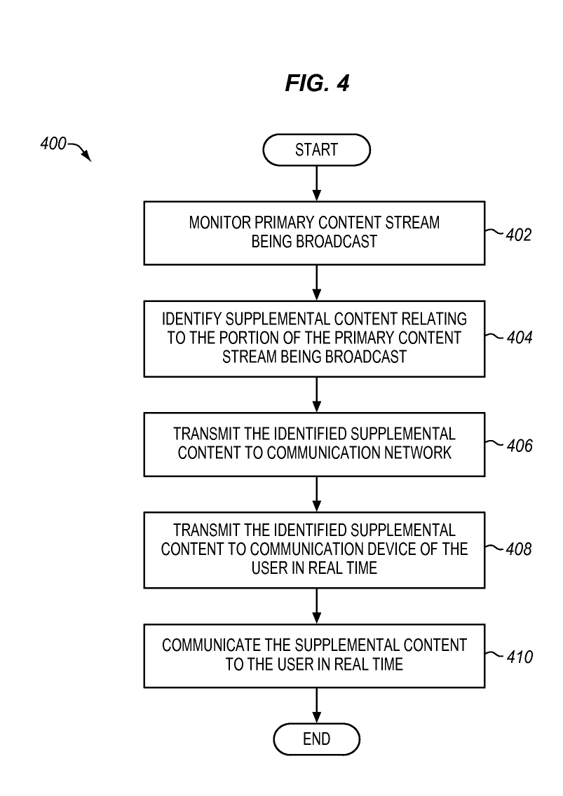

In one embodiment, content provider 110 may control the synchronization through supplemental content system 114. FIG. 4 is a flow charting illustrating a method 400 of synchronizing the supplemental content in an exemplary embodiment of the invention. Supplemental content system 114 monitors the primary content stream being broadcast by primary content system 112 in step 402 (see also FIG. 1). In step 404, supplemental content system 114 identifies supplemental content (if any) that relates to the primary content stream being broadcast. For instance, if the primary content stream being broadcast is at time X in the broadcast, then supplemental content system 114 identifies supplemental content, such as a particular media clip, relating to or associated with time X of the primary content stream. Supplemental content system 114 then transmits the identified supplemental content to communication network 120 in step 406. Responsive to receiving the identified supplemental content, supplemental content system 122 transmits the supplemental content to communication device 134 in real time in step 408. Responsive to receiving the supplemental content, communication device 134 communicates the supplemental content to user 130 in real time in step 410. The synchronization is thus controlled by content provider 110.

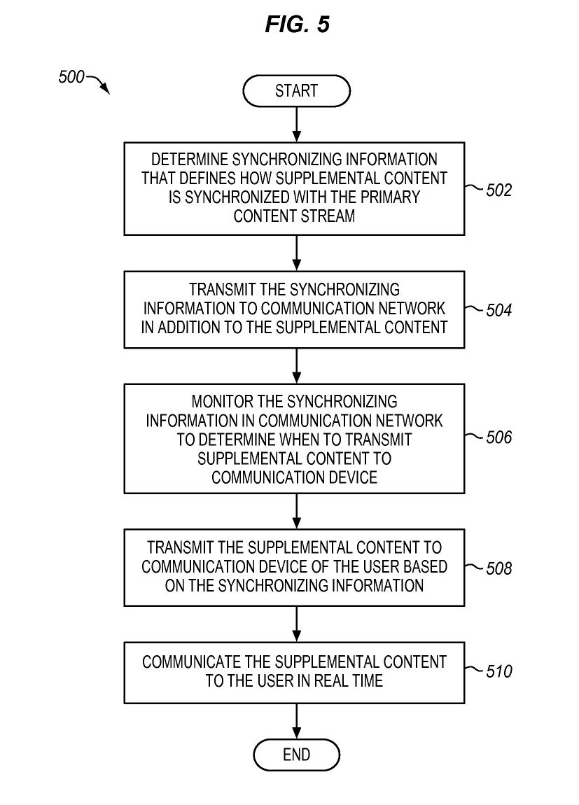

In another embodiment, content provider 110 may instruct communication network 120 to control the synchronization. FIG. 5 is a flow charting illustrating another method 500 of synchronizing the supplemental content in an exemplary embodiment of the invention. Content provider 110 determines synchronizing information that defines how supplemental content is synchronized with the primary content stream in step 502 (see also FIG. 1). The synchronizing information may comprise a series of time-based triggers or other triggers that indicate when particular supplemental content is to be communicated to user 130. Supplemental content system 114 transmits the synchronizing information to communication network 120 in addition to the supplemental content in step 504. Supplemental content system 122 then monitors the synchronizing information to determine when to transmit particular supplemental content to communication device 134 in step 506. For example, if the synchronizing information includes a time-based trigger that defines that media clip X should be played at 7:07:30 est., then supplemental content system 122 monitors an internal clock and triggers when the internal clock reaches 7:07:30 est. (or within some acceptable tolerance considering transmission delays). When appropriate, supplemental content system 122 transmits supplemental content to communication device 134 based on the synchronizing information in step 508. Responsive to receiving the supplemental content, communication device 134 communicates the supplemental content to user 130 in real time in step 510. The synchronization is thus controlled by content provider 110 and communication network 120.

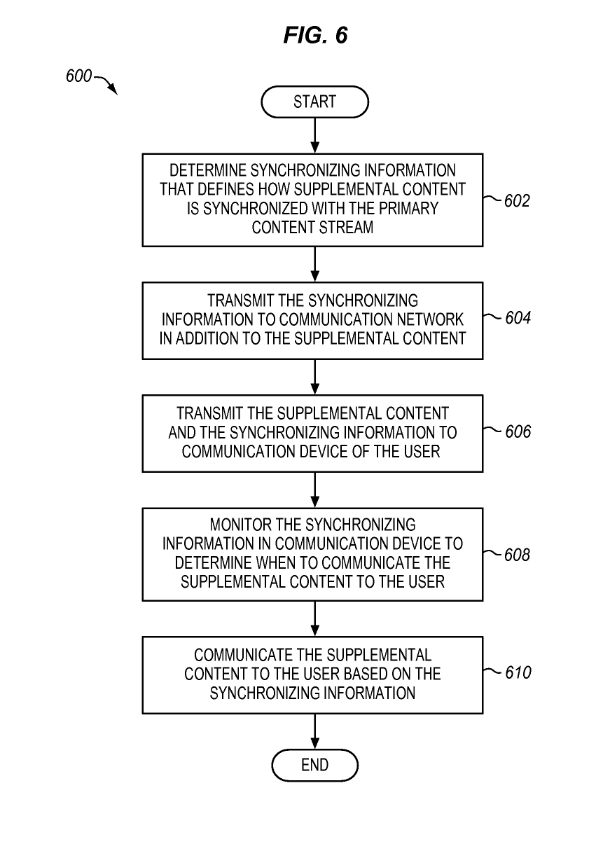

In another embodiment, content provider 110 may instruct communication device 134 to control the synchronization. FIG. 6 is a flow charting illustrating another method 600 of synchronizing the supplemental content in an exemplary embodiment of the invention. Content provider 110 again determines synchronizing information that defines how supplemental content is synchronized with the primary content stream in step 602 (see also FIG. 1). Supplemental content system 114 transmits the synchronizing information to communication network 120 in addition to the supplemental content in step 604. Supplemental content system 122 then transmits the supplemental content and the synchronizing information to communication device 134 in step 606. Communication device 134 then monitors the synchronizing information to determine when to communicate the supplemental content to user 130 in step 608. For example, if the synchronizing information includes a time-based trigger that defines that media clip X should be played at 7:07:30 est., then communication device 134 monitors an internal clock and triggers when the internal clock reaches 7:07:30 EST. When appropriate, communication device 134 communicates the supplemental content to user 130 based on the synchronizing information in step 610. The synchronization is thus controlled by content provider 110 and communication device 134.

Communication network 120 in FIG. 1 may also determine if all or a subset of the supplemental content provided by content provider 110 should be provided to user 130. For instance, if the supplemental content includes thirty separate media clips, then communication network 120 may use policy-based decision making to determine if all thirty media clips should be provided to user 130 or if a subset of the media clips should be provided.

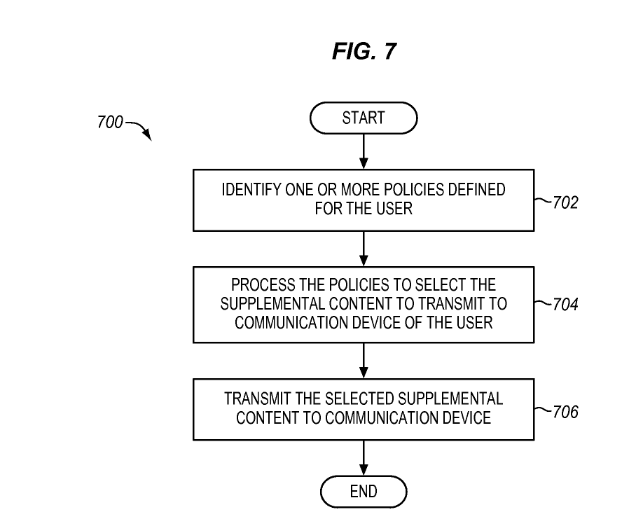

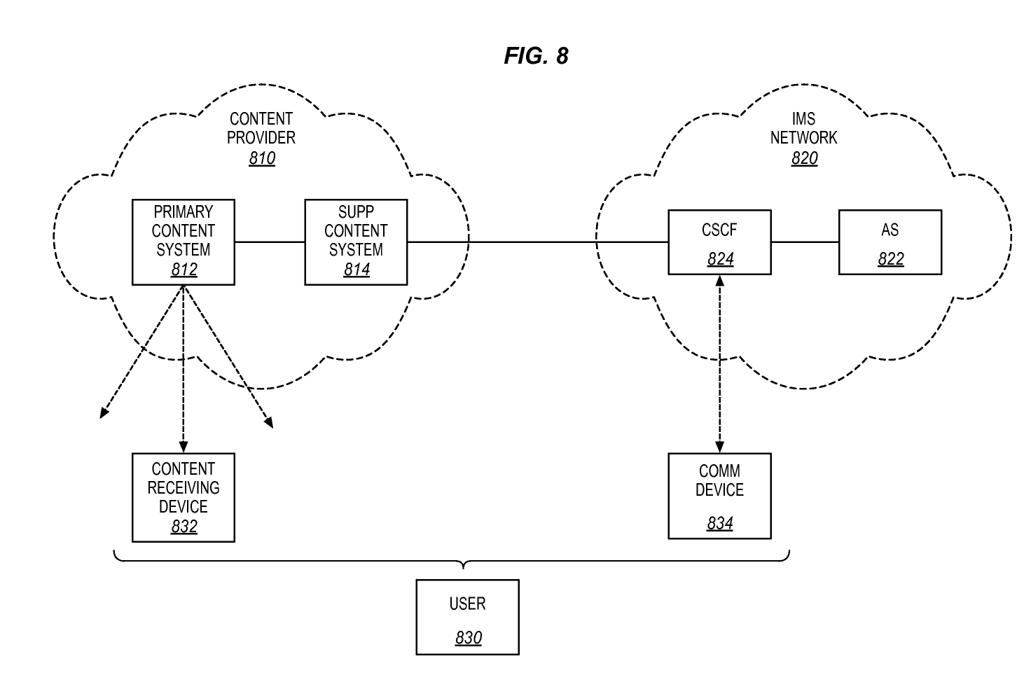

FIG. 7 is a method 700 of implementing a policy-based decision function in an exemplary embodiment of the invention. In step 702, supplemental content system 122 identifies one or more policies defined for user 130 responsive to receiving supplemental content from content provider 110. The polices may be defined by user 130 or may be defined by the service provider operating communication network 120. In step 704, supplemental content system 122 processes the policies to select the supplemental content, such as one or more media clips, to transmit to communication device 134. In step 706, supplemental content system 122 transmits the selected supplemental content to communication device 134. The selected supplemental content may include all of the content, a subset of the content, or none of the content.

One of the policies may be an overall or localized congestion on communication network 120, which may affect whether all or only some of the supplemental content can be provided to user 130. Another one of the policies may be a time of day. User 130 may request that no supplemental content be provided to communication device 134 by communication network 120 after a particular time, such as 10:00 pm. Another one of the policies may be a level or grade of service subscribed to by user 130. If user 130 subscribes to a high grade of service, then the policy may define that all of the supplemental content can be provided to user 130. If user 130 subscribers to a low grade of service, then the policy may define that only a subset of the supplemental content can be provided to user 130.

FIG. 8 illustrates another environment for providing a supplemental content service in an exemplary embodiment of the invention. FIG. 8 resembles FIG. 1 except that the communication network in FIG. 8 is comprised of an IMS network 820. IMS network 820 includes a Call Session Control Function (CSCF) 824 and an Application Server (AS) 822. AS 822 provides the functionality of a supplemental content system. CSCF 824 provides session control with supplemental content system 814 of content provider 810 and with communication device 834 of user 830.

As in the previous embodiments, content provider 810 generates a primary content stream, such as a television program, a radio program, etc. Content provider 810 also generates supplemental content which enhances the primary content stream. Primary content system 812 of content provider 810 then broadcasts the primary content stream for receipt by content receiving device 832 of user 830 and other receiving devices within range of the broadcast. Supplemental content system 814 of content provider 810 also transmits the supplemental content to IMS network 820.

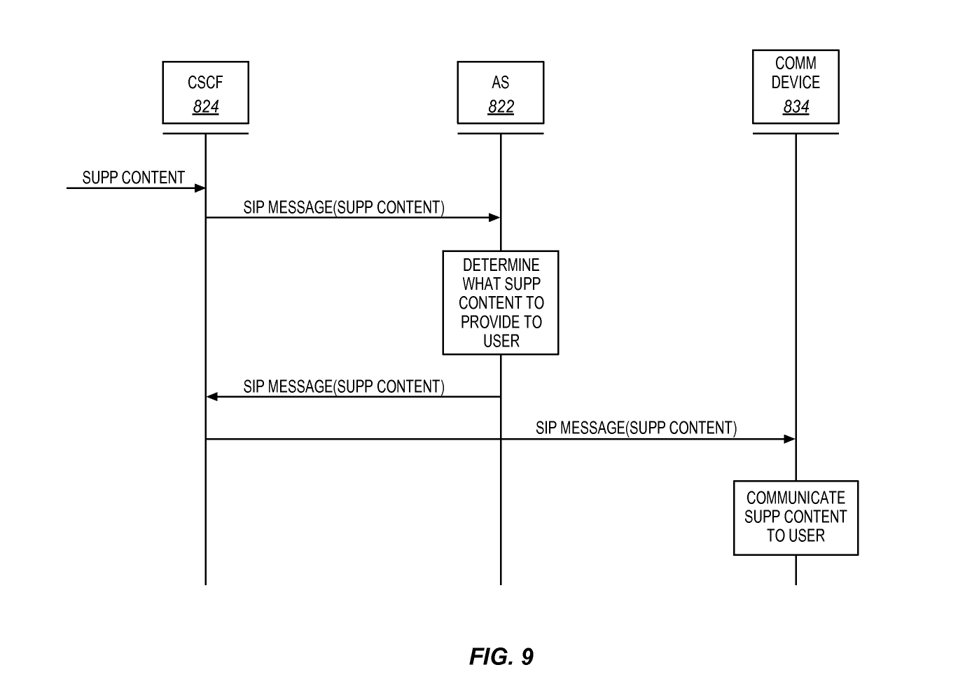

FIG. 9 is a message diagram illustrating messaging in IMS network 820 to provide the supplemental content service in an exemplary embodiment of the invention. CSCF 824 receives the supplemental content that was transmitted by content provider 810. CSCF 824 may also receive other information from content provider 810, such as synchronizing information. IMS network 820 is SIP based in this embodiment, so CSCF 824 may receive the supplemental information in a SIP message if supplemental content system 814 is SIP enabled. If supplemental content system 814 is not SIP enabled, then CSCF 824 may receive the supplemental content through a gateway (not shown). Responsive to receiving the supplemental content, CSCF 824 transmits a SIP MESSAGE (which is the MESSAGE method defined in SIP) to AS 822. The SIP MESSAGE includes the supplemental content and possibly other information. For instance, the supplemental content may be included in a Session Description Protocol (SDP) portion of the SIP MESSAGE.

Responsive to receiving the supplemental content, AS 822 determines what supplemental content to provide to user 830. AS 822 may include a policy-based decision function that determines what supplemental content to provide to user 830 based on one or more defined policies. AS 822 may also process synchronizing information, such as time-based triggers, to determine what supplemental content to provide to user 830. Responsive to determining that particular supplemental content is to be provided to user 830, AS 822 transmits a SIP MESSAGE to CSCF 824 that includes the particular supplemental content. CSCF 824 in turn transmits the SIP MESSAGE to communication device 834. One assumption in this embodiment is that communication device 834 is SIP enabled. If it is not, then CSCF 824 would transmit the SIP MESSAGE to the appropriate gateway (not shown) to convert the SIP MESSAGE to a protocol compliant with communication device 834.

Communication device 834 receives the supplemental content and communicates the supplemental content to user 830 through an audio and/or a video interface. Concurrently, content receiving device 832 communicates the primary content stream to user 830 through an audio and/or a video interface (see also FIG. 8). The supplemental content, when communicated to user 830 by communication device 834, supplements the primary content stream when the primary content stream is communicated to user 830 by content receiving device 832. Providing the supplemental content while user 830 is viewing or listening to the primary content stream advantageously provides user 830 with a more interactive and enjoyable experience.

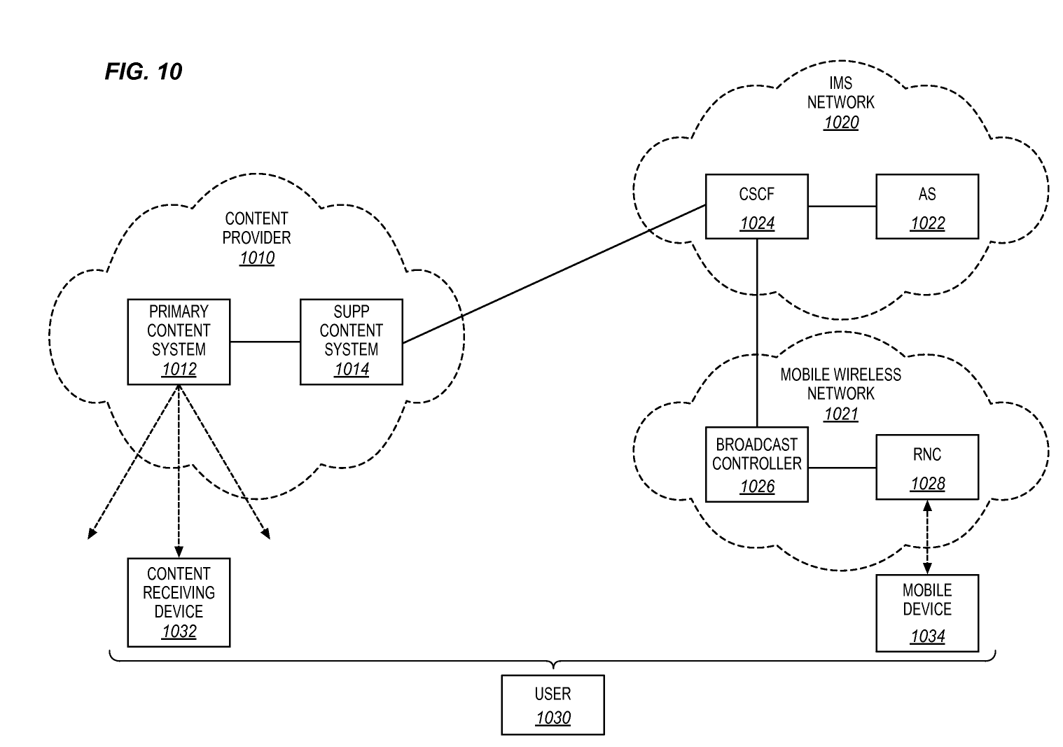

FIG. 10 illustrates another environment for providing a supplemental content service in an exemplary embodiment of the invention. FIG. 10 resembles FIG. 8 except that the communication network in FIG. 10 is comprised of an IMS network 1020 and a mobile wireless network 1021. Mobile wireless network 1021 includes a broadcast controller 1026 and a radio network controller (RNC) 1028. Mobile wireless network 1021 may include other standard systems, such as base stations, an MSC, etc, which are not shown for the sake of brevity.

As in the previous embodiments, content provider 1010 generates a primary content stream, such as a television program, a radio program, etc. Content provider 1010 also generates supplemental content which enhances the primary content stream. Primary content system 1012 of content provider 1010 then broadcasts the primary content stream for receipt by content receiving device 1032 of user 1030 and other receiving devices within range of the broadcast. Supplemental content system 1014 of content provider 1010 also transmits the supplemental content to IMS network 1020.

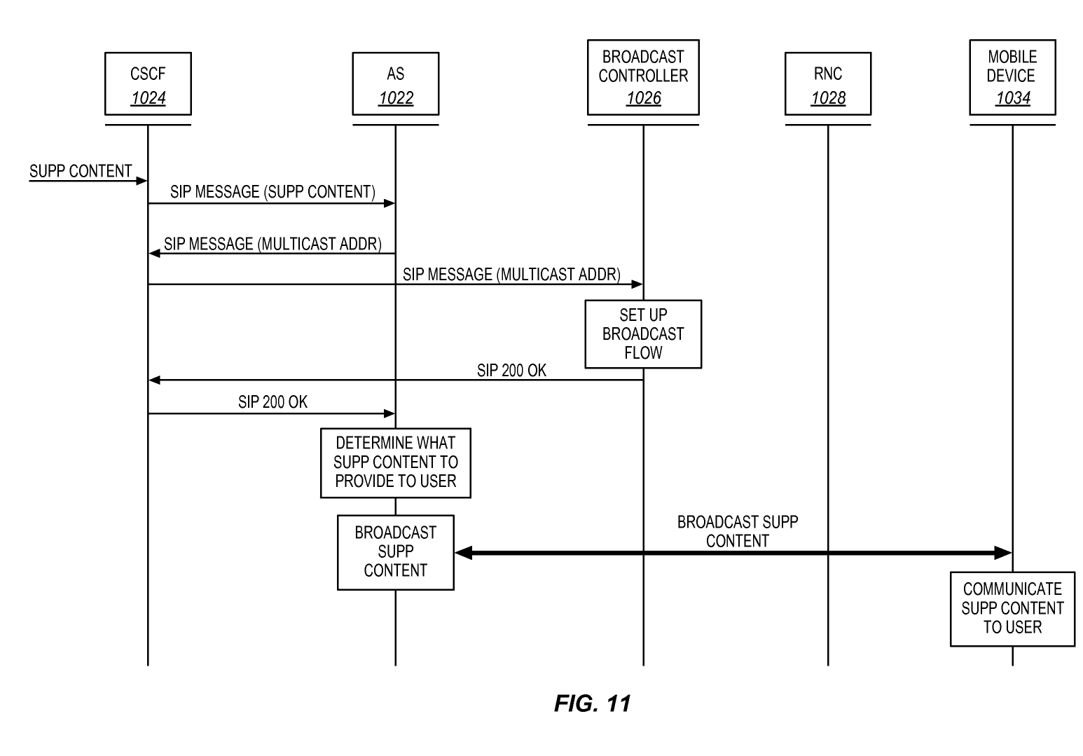

FIG. 11 is a message diagram illustrating messaging in IMS network 1020 and mobile wireless network 1021 to provide the supplemental content service in an exemplary embodiment of the invention. CSCF 1024 receives the supplemental content that was transmitted by content provider 1010. CSCF 1024 may also receive other information from content provider 1010, such as synchronizing information. Responsive to receiving the supplemental content, CSCF 1024 transmits a SIP MESSAGE to AS 1022 (which is the MESSAGE method defined in SIP). The SIP MESSAGE includes the supplemental content and possibly other information.

When AS 1022 receives the supplemental content, AS 1022 contacts the broadcast controller 1026 to establish a broadcast flow for the supplemental content. AS 1022 thus transmits a SIP MESSAGE that includes a multicast IP address to CSCF 1024. CSCF 1024 forwards the SIP MESSAGE to broadcast controller 1026. Responsive to receiving the SIP MESSAGE, broadcast controller 1026 sets up the broadcast flow for the supplemental content. Setting up the broadcast flow may include identifying subscribers to the supplemental content service in mobile wireless network 1021, allocating resources in mobile wireless network 1021 for the flow, instructing the mobile devices of the subscribers which channel to monitor to receive the broadcast flow, etc. With the broadcast flow established, broadcast controller 1026 transmits a SIP 200 OK to CSCF 1024. CSCF 1024 in turn forwards the SIP 200 OK to AS 1022.

Responsive to receiving the SIP 200 OK, AS 1022 determines what supplemental content to provide to user 1030. AS 1022 may include a policy-based decision function that determines what supplemental content to provide to user 1030 based on one or more defined policies. AS 1022 may also process synchronizing information, such as time-based triggers, to determine what supplemental content to provide to user 1030. Responsive to determining that particular supplemental content is to be provided to user 1030, AS 1022 broadcasts the particular supplemental content over the broadcast flow based on the IP address of the flow.

Communication device 1034 receives the broadcast of the supplemental content, and communicates the supplemental content to user 1030 through an audio and/or a video interface. Concurrently, content receiving device 1032 communicates the primary content stream to user 1030 through an audio and/or a video interface (see also FIG. 10). The supplemental content, when communicated to user 1030 by communication device 1034, supplements the primary content stream when the primary content stream is communicated to user 1030 by content receiving device 1032. Providing the supplemental content while user 1030 is viewing or listening to the primary content stream advantageously provides user 1030 with a more interactive and enjoyable experience.

### EXAMPLE

The following provides an example illustrating the advantages of the supplemental content service as described herein. Assume that a television production company produces a television program having a character that is an undercover agent. During the television program, there may be scene where the undercover agent asks to receive a satellite image on his/her mobile phone. Assume that the actual satellite image is not displayed to the public in this scene. The supplemental content service may be used to transmit the actual satellite image to the mobile phone of a viewer (that subscribes to the supplemental content service) so that the viewer feels as if he/she is receiving the same satellite image as the undercover agent. The viewer is thus more interactive in the viewing of the television program. In another scene of the television program, the undercover agent may receive a call on his/her mobile phone. Assume that the public only hears what the undercover agent is saying and does not hear what the voice on the mobile phone is saying. The supplemental content service may be used to place a call to the mobile phone of the viewer and play the other side of the conversation to the viewer. The viewer thus feels as if he/she is part of the same phone conversation as the undercover agent.

The supplemental content service advantageously provides the viewer with a more interactive viewing experience. The supplemental content service can thus be an advantage to the content providers, to the communication service providers, and to the subscribers of the service.

Although specific embodiments were described herein, the scope of the invention is not limited to those specific embodiments. The scope of the invention is defined by the following claims and any equivalents thereof.

We claim:

1. A method of operating a communication network to provide a supplemental content service, the communication network operating in association with a content provider that is adapted to broadcast a primary content stream to a content receiving device of a user, the method comprising:
receiving a request from a user for supplemental content associated with the primary content stream provided by the content provider;
receiving the supplemental content from the content provider; and
transmitting the supplemental content to a communication device of the user;
wherein the supplemental content, when communicated to the user by the communication device, supplements the primary content stream when the primary content stream is communicated to the user by the content receiving device.

2. The method of claim 1 wherein the supplemental content is synchronized with the primary content stream so that particular supplemental content, when communicated to the user by the communication device, relates to the portion of the primary content stream being communicated to the user by the content receiving device.

3. The method of claim 1 wherein transmitting the supplemental content to a communication device of the user comprises:
transmitting the supplemental content to the communication device of the user in real-time responsive to receiving the supplemental content from the content provider.

4. The method of claim 1 further comprising:
receiving synchronizing information from the content provider; and
transmitting the supplemental content to the communication device of the user based on the synchronizing information.

5. The method of claim 1 further comprising:
receiving synchronizing information from the content provider; and
transmitting the supplemental content and the synchronizing information to the communication device of the user, wherein the communication device communicates the supplemental content to the user based on the synchronizing information.

6. The method of claim 1 wherein transmitting the supplemental content to a communication device of the user comprises:
broadcasting/multicasting the supplemental content for receipt by the communication device of the user.

7. The method of claim 1 further comprising:
identifying policies defined for the user responsive to receiving the supplemental content;
processing the policies to select the supplemental content to transmit to the communication device of the user; and
transmitting the selected supplemental content to the communication device of the user.

8. The method of claim 7 wherein processing the policies to select the supplemental content comprises:
processing the policies and congestion of the communication network to select the supplemental content to transmit to the communication device of the user.

9. The method of claim 7 wherein processing the policies to select the supplemental content comprises:
processing the policies and time of day to select the supplemental content to transmit to the communication device of the user.

10. The method of claim 1 wherein the supplemental content includes advertising material.

11. The method of claim 1 wherein the communication network comprises a mobile wireless network and the communication device comprises a mobile device.

12. The method of claim 1 wherein the supplemental content comprises at least one of an audio clip, a video clip, a text/multimedia message, and a digital picture.

13. A method of operating a communication network to provide a supplemental content service for television programs that are broadcast by a content provider, the method comprising:
receiving a request from a user for supplemental content associated with a television program provided by the content provider;
receiving at least one media clip from the content provider; and
transmitting the at least one media clip to a communication device of the user that is adapted to communicate the at least one media clip to the user;
wherein the at least one media clip, when communicated to the user through the communication device, is adapted to supplement the television program when viewed by the user through the television.

14. The method of claim 13 wherein the at least one media clip is synchronized with the television program so that a particular media clip, when communicated to the user by the communication device, relates to a particular segment of the television program being displayed to the user by the television.

15. The method of claim 13:
wherein the communication network comprises a mobile wireless network; and
wherein transmitting the at least one media clip to a communication device of the user comprises broadcasting/multicasting the at least one media clip for receipt by the communication device of the user.

16. The method of claim 13 wherein the at least one media clip comprises at least one of an audio clip, a video clip, a text/multimedia message, and a digital picture.

17. A method, comprising:
generating a primary content stream;
generating supplemental content, wherein the supplemental content enhances the primary content stream when the supplemental content and the primary content stream are provided to a user;
broadcasting the primary content stream to a content receiving device of the user; and
transmitting the supplemental content to a communication network, wherein the communication network is adapted to transmit the supplemental content to the user through a communication device.

18. The method of claim 17 further comprising:
generating synchronizing information to synchronize the supplemental content with the primary content stream; and
transmitting the synchronizing information to the communication network in addition to the supplemental content.

19. The method of claim 17 wherein the primary content stream comprises a television program and the supplemental content comprises at least one media clip that enhances the television program.

20. The method of claim 19 wherein the at least one media clip comprises at least one of an audio clip, a video clip, a text/multimedia message, and a digital picture.
